(19) United States
(12) Patent Application Publication
(10) Pub. No.: US 2016/0265596 A1
(43) Pub. Date: Sep. 15, 2016

(54) BALL TYPE UNIVERSAL JOINT

(71) Applicant: RE-DAI Precision Tools Co., LTD., Taichung City (TW)

(72) Inventor: HSIANG CHEN YU, Taichung City (TW)

(21) Appl. No.: 14/676,854

(22) Filed: Apr. 2, 2015

(30) Foreign Application Priority Data
Mar. 12, 2015 (TW) 104107974

(51) Int. Cl. F16D 3/18; B25B 23/00

(52) U.S. Cl. CPC F16D 3/185; B25B 23/0014

(57) ABSTRACT

A ball type universal joint includes a coupling member and a socket member combined together. The socket member has a ball head and lugs projectingly formed on a surface of the ball head. A surface between two neighboring lugs is a spherical surface. The coupling member has a cylindrical coupling hole. Ribs are projectingly formed on a wall surface of the cylindrical coupling hole. One side of each rib is a protrusion surface, and a lengthwise extending direction of the protrusion surface is an extending direction of a straight line. The ball head is coupled to the cylindrical coupling hole. Each lug is disposed between two ribs. Each rib is disposed between two lugs and corresponds to the spherical surface. A combination of the coupling member and the socket member may be adjusted into an angled state. The spherical surface is tangent to a protrusion surface of the rib.

### BACKGROUND OF THE INVENTION

1. Field of the Invention

The invention relates to a universal joint, and more particularly to a ball type universal joint, which is adapted to a power tool or a manually operated tool, and can transfer an acting force to a fastener or other workpieces by way of offsetting.

2. Related Art

A typical ball type universal joint, such as that disclosed in U.S. Pat. No. 2,441,347, has a coupling mechanism which is a combination of a pin and a ball. In the universal joint, the pin and the ball withstand the shearing force upon use. So, the universal joint usually fails due to the breaking or cracking of the pin.

Furthermore, U.S. Pat. No. 4,834,418 discloses one member having one end formed with a ball, wherein ribs are formed on the surface of the ball; and the other member having one end formed with an accommodating hole having a meshing structure. The ball is accommodated within the accommodating hole, and the ribs of the ball surface mesh with the meshing structure. The design of the ball and the meshing structure may not use the pin, but the ball and the meshing structure form the high adaptation meshing. So, it is not easy to adjust the relative position between the two members.

Moreover, U.S. Pat. No. 6,869,366 discloses one member having one end formed with a ball, wherein ribs are formed on the surface of the ball; and the other member having one end formed with an accommodating hole, wherein separate projections are formed in the accommodating hole. A surface between the two neighboring ribs is a flat surface. A bottom portion of the accommodating hole is formed with a spherical cavity, and the bottom portion of the projection abuts upon an edge of the spherical cavity. Adjusting the relative angle between the two members, the flat surface between the two ribs can be rotated along the curvature of the spherical cavity and rests against the lower edge of the projection. However, the wall surface of the projection in the accommodating hole is in the hanging state, and the bottom portion of the accommodating hole needs to have the ball-shaped cavity, so the accommodating hole has the complicated structure and is difficult to be manufactured.

### SUMMARY OF THE INVENTION

An object of the invention is to provide a ball type universal joint, which enables a tool to transfer an acting force to a workpiece, and allows an angled state to be formed between the tool and the workpiece.

Another object of the invention is to provide a universal joint having the enhanced shearing structural strength by the design of a coupling mechanism, and the universal joint can be manufactured more conveniently.

To achieve the above-identified objects and effects, the invention discloses a ball type universal joint for transferring an acting force from a tool to a workpiece. The universal joint comprises a coupling member and a socket member combined together. The coupling member has a cylindrical coupling hole, which is disposed on a central axis of the coupling member and has one end formed with an opening. The socket member has a workpiece socket and a ball head extending from one end of the workpiece socket. Further, a plurality of ribs is projectingly formed on an inner wall surface of the cylindrical coupling hole, wherein each rib is parallel to the central axis of the coupling member and has a side surface being a protrusion surface. A lengthwise extending direction of the protrusion surface is an extending direction of a straight line. A plurality of lugs is projectingly formed on a surface of the ball head, and a side surface of each lug is an arced surface. Spherical surfaces are disposed between the lugs, respectively. Moreover, the ball head is combined with the cylindrical coupling hole, each lug is disposed between two ribs, and each rib is disposed between two lugs and corresponds to the spherical surface. A combination of the coupling member and the socket member may be adjusted into an angled state, and the spherical surface is tangent to the protrusion surface of the rib.

### BRIEF DESCRIPTION OF THE DRAWINGS

FIG. 1 shows a pictorially assembled view of the invention.

FIG. 2 shows an exploded view of the invention.

FIG. 3 is a schematic structure view showing a coupling member of the invention.

FIG. 4 is a pictorial view showing a socket member of the invention.

FIG. 5 is a schematic structure view showing the socket member of the invention.

FIG. 6 a schematic view showing an assembled structure of the invention.

FIG. 7 is a schematic view showing an assembled structure of a ball and a cylindrical coupling hole of the invention.

FIG. 8 is a schematic structure view showing a socket member and a coupling member adjusted to an angled state according to the invention.

### DETAILED DESCRIPTION OF THE INVENTION

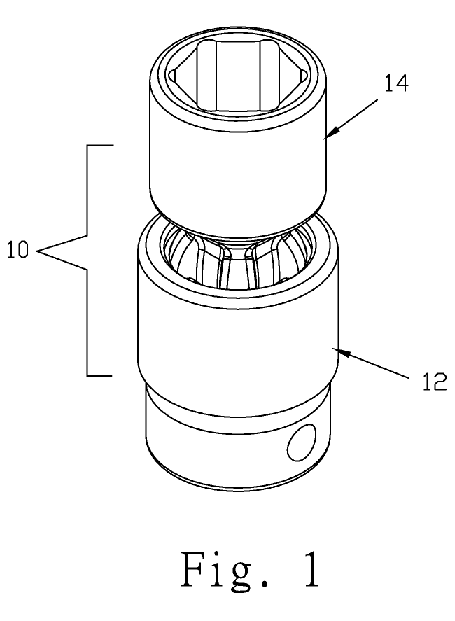

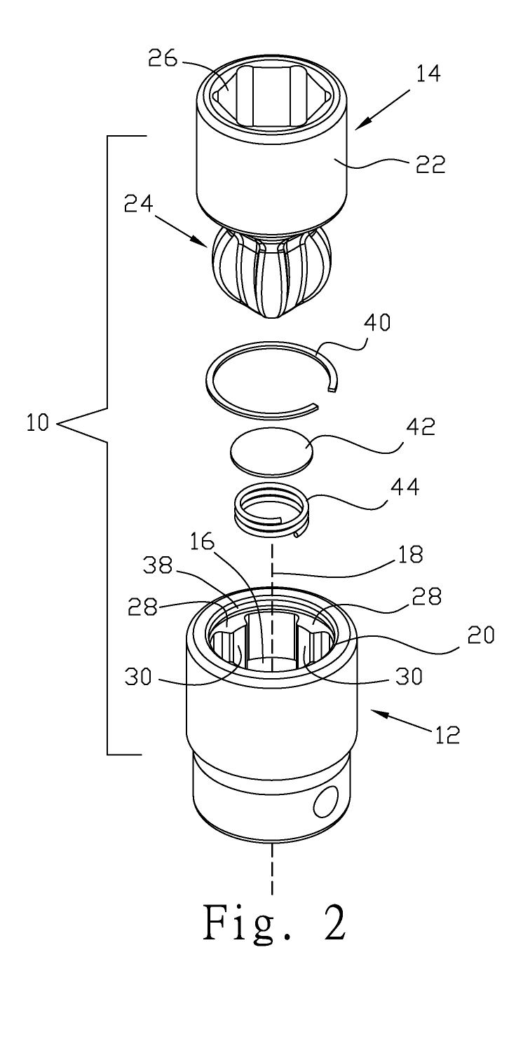

Referring to FIGS. 1 and 2, the invention discloses a ball type universal joint 10 comprising a coupling member 12 and a socket member 14 combined together. The coupling member 12 is attachable to a tool, such as an impact wrench, a ratchet wrench or other similar pneumatic tool, a power tool or a hand tool. The socket member 14 is attachable to a workpiece.

Referring again to FIG. 2, the tool mates with a square drive recess on one end of the coupling member 12. The other end of the coupling member 12 (an end opposite to the square drive recess) has a cylindrical coupling hole 16, which is disposed on a central axis 18 of the coupling member 12, and has one end formed with an opening 20. The socket member 14 has a workpiece socket 22 and a ball head 24. The ball head 24 extends from one end of the workpiece socket 22, and the workpiece is attachable to a socket 26 of the workpiece sleeve 22.

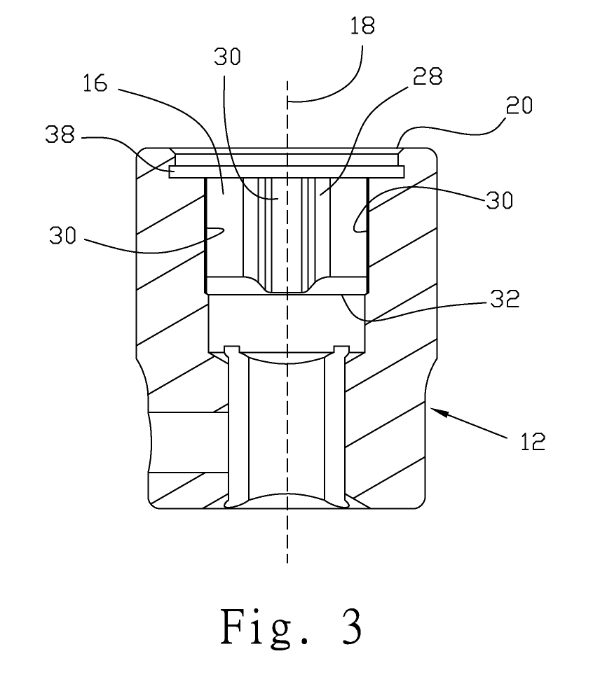

Referring to FIGS. 2 and 3, a plurality of ribs 28 is projectingly formed on an inner wall surface of the cylindrical coupling hole 16, and each rib 28 is parallel to the central axis 18 of the coupling member 12. Furthermore, a side surface of each rib 28 is a protrusion surface 30, and a lengthwise extending direction of the protrusion surface 30 parallel to a direction of the central axis 18 is an extending direction of a straight line. Next, one end of the rib 28 abuts upon the opening 20 of the cylindrical coupling hole 16, and the other end of the rib 28 abuts upon a bottom portion 32 of the cylindrical coupling hole 16 (see FIG. 3).

Also, an annular embedding groove 38 is formed on the inner wall surface of the cylindrical coupling hole 16 of the coupling member 12, and the annular embedding groove 38 is disposed between the opening 20 of the cylindrical coupling hole 16 and an end portion of the rib 28.

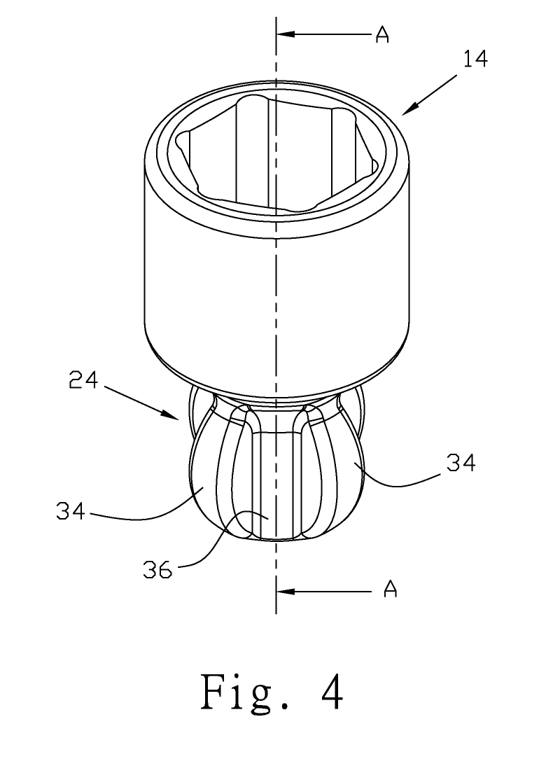

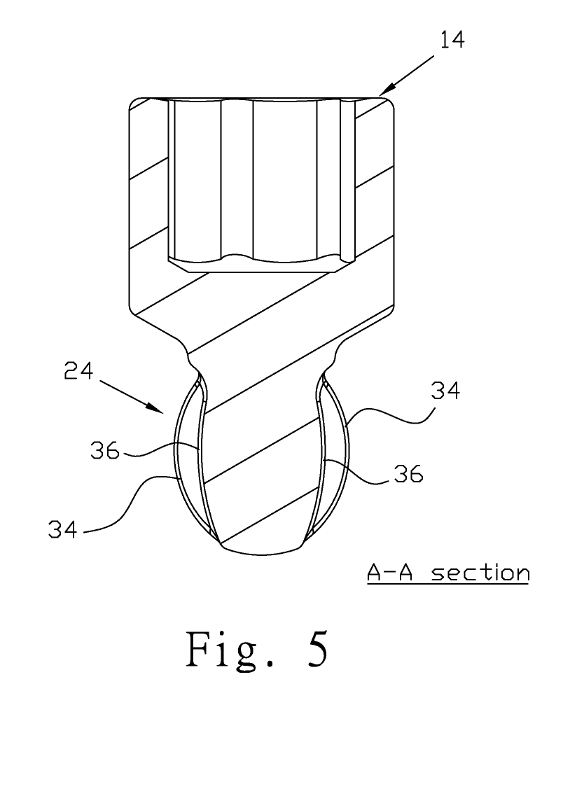

Referring to FIGS. 4 and 5, a plurality of lugs 34 is projectingly formed on a surface of the ball head 24 of the socket member 14. A side surface of each lug 34 is an arced surface. Spherical surfaces 36 are disposed between the neighboring lugs 34.

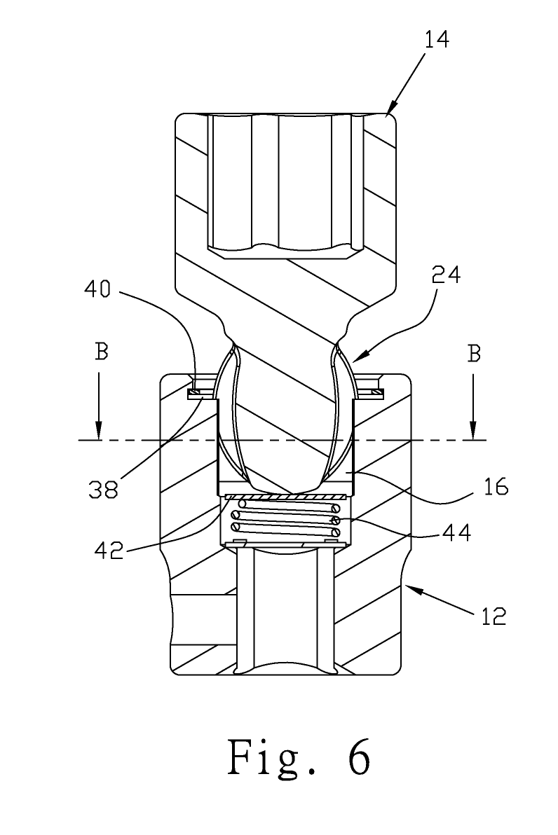

Referring to FIGS. 1 and 6, the ball head 24 of the socket member 14 is mounted in the cylindrical coupling hole 16 of the coupling member 12. A positioning ring 40 mounted in the annular embedding groove 38 restricts the coupling member 12 from separating from the socket member 14. In addition, a combination of a gasket 42 and a spring 44 may be mounted in the cylindrical coupling hole 16 and disposed on one end of the ball head 24.

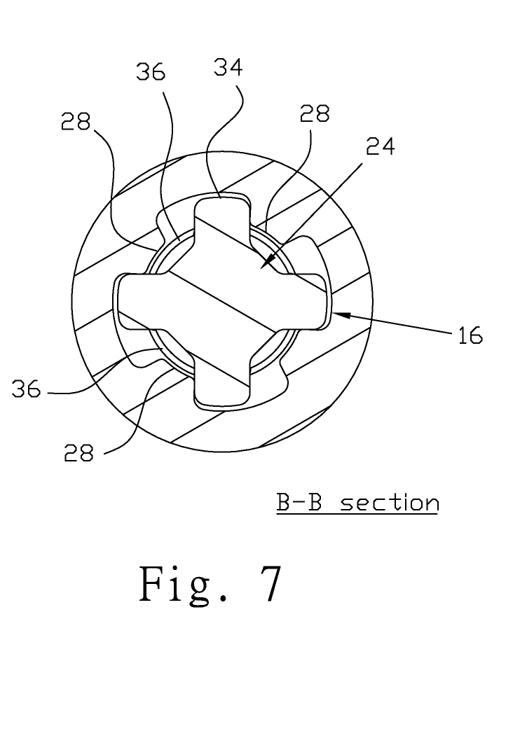

Referring to FIG. 7, in a combination state of the ball head 24 and the cylindrical coupling hole 16, each lug 34 is disposed between two ribs 28, and each rib 28 is disposed between two lugs 34 and corresponds to the spherical surface 36.

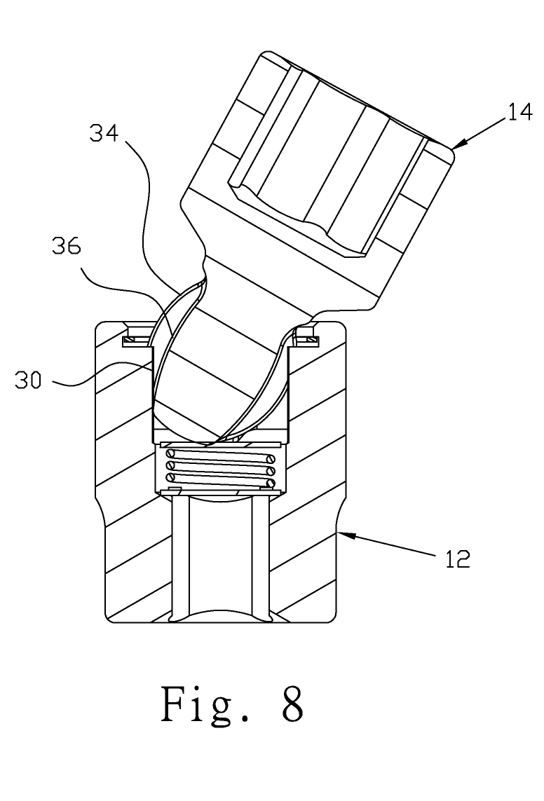

Referring to FIG. 8, because the lengthwise extending direction of the protrusion surface 30 is straightforward and extends in between the lugs 34, the coupling member 12 and the socket member 14 may be adjusted into an angled state, and the spherical surface 36 is tangent to the protrusion surface 30, so that the relative position between the coupling member 12 and the socket member 14 can be smoothly adjusted.

Because the length of the rib 28 approaches the length of the cylindrical coupling hole 16, the larger contact area may be formed between the lug 34 and the rib 28, so that the larger driving acting force and the larger shearing force can be withstood. In addition, the length of the rib 28 approaches the length of the cylindrical coupling hole 16, and the lengthwise extending direction of the protrusion surface 30 is straightforward, so the structure of the coupling member 12 can be manufactured by way of forging and can be easily demolded and the manufacturing processes become more convenient.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A ball type universal joint for transferring an acting force, the ball type universal joint comprising:
a coupling member having a cylindrical coupling hole, which is disposed on a central axis of the coupling member and has one end formed with an opening;
a socket member having a workpiece socket and a ball head extending from one end of the workpiece socket;
a plurality of ribs projectingly formed on an inner wall surface of the cylindrical coupling hole, wherein each of the ribs is parallel to the central axis of the coupling member, and has a side surface being a protrusion surface, and a lengthwise extending direction of the protrusion surface is an extending direction of a straight line;
a plurality of lugs projectingly formed on a surface of the ball head, wherein each of the lugs has a side surface being an arced surface; and
a plurality of spherical surfaces disposed between the lugs;
wherein the ball head is combined with the cylindrical coupling hole, each of the lugs is disposed between neighboring two of the ribs, each of the ribs is disposed between neighboring two of the lugs and corresponds to the spherical surface; wherein when the coupling member and the socket member are adjusted to an angled state, the spherical surface is tangent to a protrusion surface of the rib.

2. The ball type universal joint according to claim 1, wherein one end of the rib abuts upon the opening of the cylindrical coupling hole, and the other end of the rib abuts upon a bottom portion of the cylindrical coupling hole.

3. The ball type universal joint according to claim 2, further comprising an annular embedding groove and a positioning ring, wherein the annular embedding groove is formed on the inner wall surface of the cylindrical coupling hole of the coupling member, and the annular embedding groove is disposed between the opening of the cylindrical coupling hole and an end portion of the rib, wherein the positioning ring is mounted in the annular embedding groove and restricts the coupling member from separating from the socket member.
